(19) United States
(12) Patent Application Publication
(10) Pub. No.: US 2013/0304438 A1
(43) Pub. Date: Nov. 14, 2013

(54) USE OF SURVIVAL MODELING METHODS WITH PIPELINE INSPECTION DATA FOR DETERMINING CAUSAL FACTORS FOR CORROSION UNDER INSULATION

(71) Applicants: Richard S. Bailey, Surrey (GB); Kip P. Sprague, Anchorage, AK (US); Eric Ziegel, Houston, TX (US)

(72) Inventors: Richard S. Bailey, Surrey (GB); Kip P. Sprague, Anchorage, AK (US); Eric Ziegel, Houston, TX (US)

(73) Assignees: BP EXPLORATION OPERATING COMPANY LIMITED, Sunbury-On-Thames (GB); BP CORPORATION NORTH AMERICA INC., Houston, TX (US)

(21) Appl. No.: 13/467,753

(22) Filed: May 9, 2012

(51) Int. Cl. G06G 7/48

(52) U.S. Cl. 703/6

(57) ABSTRACT

Methods and systems for using survival modeling methods with pipeline inspection data to determine causal factors for corrosion under insulation comprise determining a first corrosion condition of a pipeline joint at a first time; determining a second corrosion condition of the pipeline joint at a second, subsequent time; determining joint attributes, pipeline attributes, and location attributes associated with the pipeline joint; and repeating the process for a plurality of pipeline joints in one or more pipelines. This information is fed into a multiple regression and survival analysis process that determines regression coefficients reflecting the estimated degrees to which various factors contribute to corrosion under insulation. The survival analysis also determines one or more survival models capable of predicting when a given pipeline joint is likely to transition from a first corrosion state to a different second corrosion state, given values for its various attributes.

### TECHNICAL FIELD

The present disclosure relates generally to the field of pipeline inspection, and is more specifically directed to using survival modeling analysis to predict corrosion under insulation for a plurality of pipeline joints.

### BACKGROUND

In the energy industry, it is frequently necessary to transport large amounts of oil and natural gas over long distances—for example, from one or more drilling and extraction sites to one or more refineries. Typically, such transport is accomplished using large networks of oil or natural gas pipelines that, together, constitute an oil and gas production field. FIG. 1 depicts an exemplary oil and gas production field, for purposes of illustration.

As depicted in FIG. 1, a production field can include multiple wells 4, deployed at various locations within the field, from which oil and gas products are extracted. Each well 4 can be connected to a drill site 2 in its locale by way of a pipeline 5. By way of example, eight drill sites 2₀ through 2₇ are illustrated in FIG. 1. Each drill site 2 can support a plurality of wells 4; for example, drill site 2₃ is illustrated in FIG. 1 as supporting forty-two wells 4₀ through 4₄₁. Each drill site 2 can receive the output from its associated wells 4 and forward the output to a central processing facility 6 via one of pipelines 5. Central processing facility 6 can be coupled to an output pipeline 5, which in turn can connect to a larger-scale pipeline facility along with other central processing facilities 6. In actual oil fields, such as those deployed in the Trans-Alaska Pipeline System, thousands of individual pipelines can be interconnected within the overall production and processing system. As such, the pipeline system illustrated in FIG. 1 may represent only a portion of an overall production pipeline system.

Typically, pipelines are constructed in an incremental manner by welding together a series of pipeline segments or legs. For example, as depicted in FIG. 2A, an exemplary pipeline 200 includes a plurality of constituent pipeline segments 210-240. By constructing pipeline 200 out of constituent pipeline segments 210-240, it may be easier to transport the components necessary to build pipeline 200 from their place of manufacture to the production field. Pipeline construction using constituent segments may also lower the cost of maintenance or repair of a pipeline, by allowing maintenance, repair, or replacement to be limited to only certain, individual pipeline segments, rather than the pipeline as a whole. Those skilled in the art will appreciate that the pipeline and pipeline segments depicted in FIG. 2A are for purposes of illustration only and may not be drawn to scale.

Pipeline 200 can include a layer of surrounding insulation 202, also known as lagging. Insulation 202 can come in the form of rigid polyurethane foam or other insulating material and is used to protect the outer surface of the pipeline segments, which are typically constructed from iron alloy or other metallic materials, from environmental conditions.

FIG. 2B depicts an exemplary pipeline segment 250, which includes an insulation layer 254 and an exposed, non-insulated end 252. Typically, pipeline segments are constructed and transported to a production field for assembly in a state similar to pipeline segment 250. In particular, pipeline segment 250 can be constructed such that its insulation layer 254 does not completely cover the outside cylindrical surface of the pipeline segment 250, but rather leaves the outer ends 252 of the segment exposed. This partial insulation is typically necessary to ensure that pipeline segment 250 may be attached to another pipeline segment in the production field during the pipeline construction process.

For example, as depicted in FIG. 3, separate pipeline segments 310 and 320 can be manufactured (e.g., within an indoor facility) and transported to a production field for assembly into a larger pipeline. As part of the assembly process, pipeline segment 310 may be welded to pipeline segment 320 at an interface 330 corresponding to the respective ends of the pipeline segments, thus forming a pipeline joint 340. A layer of insulation can then be applied to pipeline joint 340.

However, because the process of applying insulation to pipeline joint 340 typically must take place outdoors, in the field where the larger pipeline structure is being assembled, pipeline joint 340 may be exposed to environmental moisture, which may remain on the outer surfaces of the pipeline segments, even after insulation is applied. Even if such moisture is minor or initially undetectable, over a long period of time, it can slowly contribute to corrosion of the outer surfaces of pipeline joints, a process known as corrosion under insulation (CUI). Although any area of a pipeline segment can suffer from CUI, the environmental exposure of pipeline joints prior to insulation may render them generally more susceptible to CUI. In addition, other events or conditions may introduce moisture to the outer surfaces of pipeline segments or joints, such as routine maintenance or deterioration of an insulation layer due to environmental conditions.

If CUI is permitted to run its course, it can eventually corrode a pipeline wall to the point of losing containment capacity, thus allowing materials transported through a pipeline to leak or escape. In addition to the economic implications of losing valuable commodities, leaking materials may remain trapped under the lagging of corroded pipelines, which may force the leaking materials to the external surfaces of adjacent containment surfaces and, thus accelerate CUI for other pipeline segments or joints. Accordingly, there is a need for methods and systems of detecting and arresting CUI in pipeline joints before they lose containment or are otherwise rendered irreparable.

However, several barriers to efficiently detecting CUI in pipeline joints exist. For example, a production field can include hundreds of different pipelines, many of which span tens or hundreds of miles, often in inhospitable environments such as Alaska. As a result, it may not be feasible to inspect each of the tens of thousands of constituent pipeline joints in the pipelines themselves, or to inspect them with sufficient frequency that would allow an inspection team to detect CUI inception before it progresses to the point of rendering a pipeline joint inoperable.

Typically, CUI progress follows a non-linear path. For example, a given pipeline joint may have a total “lifetime” of ten years between its initial placement in a production field and its reaching a corrosion state that causes it to lose containment. Although the conditions that caused the pipeline joint to undergo CUI may have been present from the beginning, CUI may not onset until year seven, after which the pipeline joint may undergo CUI, causing it to lose containment at year ten. In this example, even an otherwise statistically reliable sampling of pipelines and pipeline locations may not be effective at detecting CUI in the pipeline joint, since an inspection at year six may not detect any corrosion and a subsequent inspection at year ten may be too late. Moreover, in some production fields, the sheer number of individual pipeline joints can make it impossible to inspect each and every pipeline joint once, let alone on multiple occasions as part of any kind of periodic inspection campaign.

Finally, even when a pipeline joint is found to be undergoing CUI, known techniques have not identified any reliable way of extrapolating from the conditions of the affected pipeline joint which other pipeline joints may similarly be affected by or even vulnerable to CUI in the near future. This failure is typically due to the large number of differing attributes between distinct pipeline joints, pipelines, and locations, all of which can factor into an overall corrosion rate for a given pipeline joint. Given the myriad number of variables, known techniques have not identified any meaningful way to correlate particular pipeline conditions with the effects of particular attributes, such that conclusions can be drawn concerning what attributes caused the condition or the likely condition of other pipeline joints having overlapping, but different, sets of attribute values.

Accordingly, there is a need for methods and systems of determining meaningful correlations between pipeline joint attributes, pipeline attributes, and location attributes and the condition of pipeline joints undergoing CUI. There is a need for determining such correlations in a sufficiently meaningful way such that accurate predictions can be made concerning current states of pipeline joints, whether inspected or not, future states of pipeline joints if no intervening action is taken, and best practices that have the effect of avoiding CUI in pipelines.

### BRIEF SUMMARY

The present disclosure addresses these and other improvements in pipeline inspection and maintenance by describing novel methods of determining the factors most causative of CUI and predicting CUI in pipeline joints using survival analysis modeling techniques.

In one embodiment, pipeline joint attributes, such as a configuration, orientations, and shape, are collected for a plurality of pipeline joints in one or more pipelines and catalogued in a database. For each pipeline joint, attributes of the pipelines in which such joints reside, as well as attributes of the location of each pipeline joint, are also collected and stored in the database. As individual pipeline joints are inspected—e.g., as part of targeted or general inspection campaigns—the condition of each inspected pipeline joint with respect to CUI is determined and also catalogued in the database.

For pipeline joints in which multiple inspections have been performed, the condition of the pipeline joints at each inspection, as well as their joint attributes, pipeline attributes, and location attributes, are fed into a multiple regression analysis to determine the attributes that contribute most significantly to changes in CUI condition. Such information is also used to perform survival analysis in order to predict the likely CUI condition of various pipeline joints for which attribute information is known. Survival analysis is also used to predict likely lifetimes for various pipeline joints to determine likely CUI conditions of the pipeline joints in the future. In some embodiments, the condition of a pipeline with respect to CUI can be classified according to distinct stages, and survival analysis can be used to determine expected lifetimes of a plurality of pipeline joints for a plurality of different CUI stage progressions.

Pipeline joints for which CUI is predicted to be presently occurring can be prioritized in terms of a maintenance schedule, so that their CUI may be arrested and cured. For pipeline joints for which CUI is predicted to onset in the near future, maintenance operations can be performed to attempt to delay CUI onset. Moreover, using the information obtained about the factors that most contribute to CUI initiation, design and layout decisions can be made for future pipeline configurations or constructions. Many other applications of the disclosed embodiments may also be utilized.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an exemplary production field and oil pipeline configuration in connection with which one or more embodiments of the present disclosure may be utilized;

FIG. 2A is a diagram depicting an exemplary pipeline, consistent with certain disclosed embodiments;

FIG. 2B is a diagram depicting an exemplary pipeline segment, consistent with certain disclosed embodiments;

FIG. 3 is a diagram depicting an exemplary process for connecting two pipeline segments in the course of a larger pipeline construction, consistent with certain disclosed embodiments;

FIG. 4 is a diagram depicting exemplary hardware componentry of a system configured to perform the described embodiments, consistent with certain disclosed embodiments;

FIG. 5 is a flow diagram depicting an exemplary method of using multiple regression to determine the causal factors most relevant to the initiation of CUI and using survival analysis to predict CUI initiation in pipeline joints, consistent with certain disclosed embodiments;

FIG. 6 is a diagram depicting exemplary data that can be entered into a database to perform survival analysis, consistent with certain disclosed embodiments;

FIG. 7 is a flow diagram depicting an exemplary method of manually inspecting an individual pipeline joint, consistent with certain disclosed embodiments;

FIG. 8 is a diagram depicting exemplary attributes that can be entered into a database to perform survival analysis, consistent with certain disclosed embodiments;

FIG. 9 is a flow diagram depicting an exemplary method of entering condition and attribute data associated with an individual pipeline joint, consistent with certain disclosed embodiments;

FIG. 10 is a diagram depicting an exemplary method of providing categorized inputs, based on various CUI stages, to a multiple regression and survival analysis process, consistent with certain disclosed embodiments;

FIG. 11 is a diagram depicting an exemplary output of an exemplary multiple regression analysis, consistent with certain disclosed embodiments;

FIG. 12 is a diagram depicting an exemplary method of predicting lifetimes for various pipeline joints with respect to multiple stages of CUI using the results of survival analysis, consistent with certain disclosed embodiments; and

FIG. 13 is a chart depicting exemplary calculations of expected lifetimes for a plurality of pipeline joints with respect to multiple CUI stages, consistent with certain disclosed embodiments.

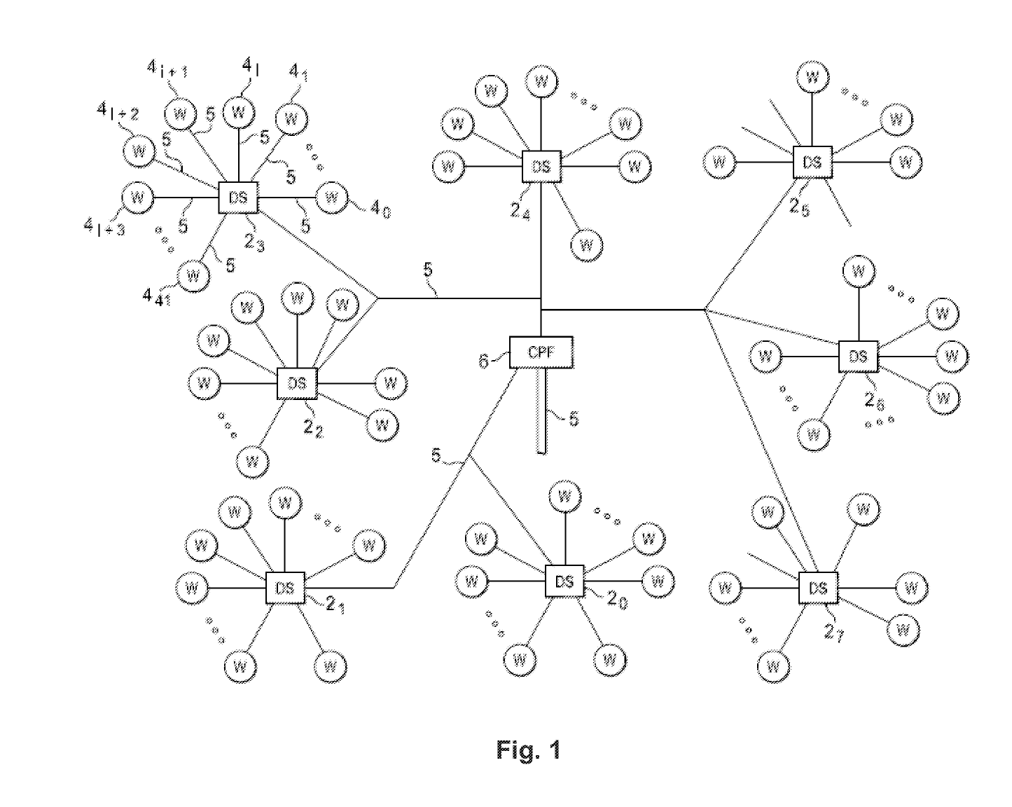

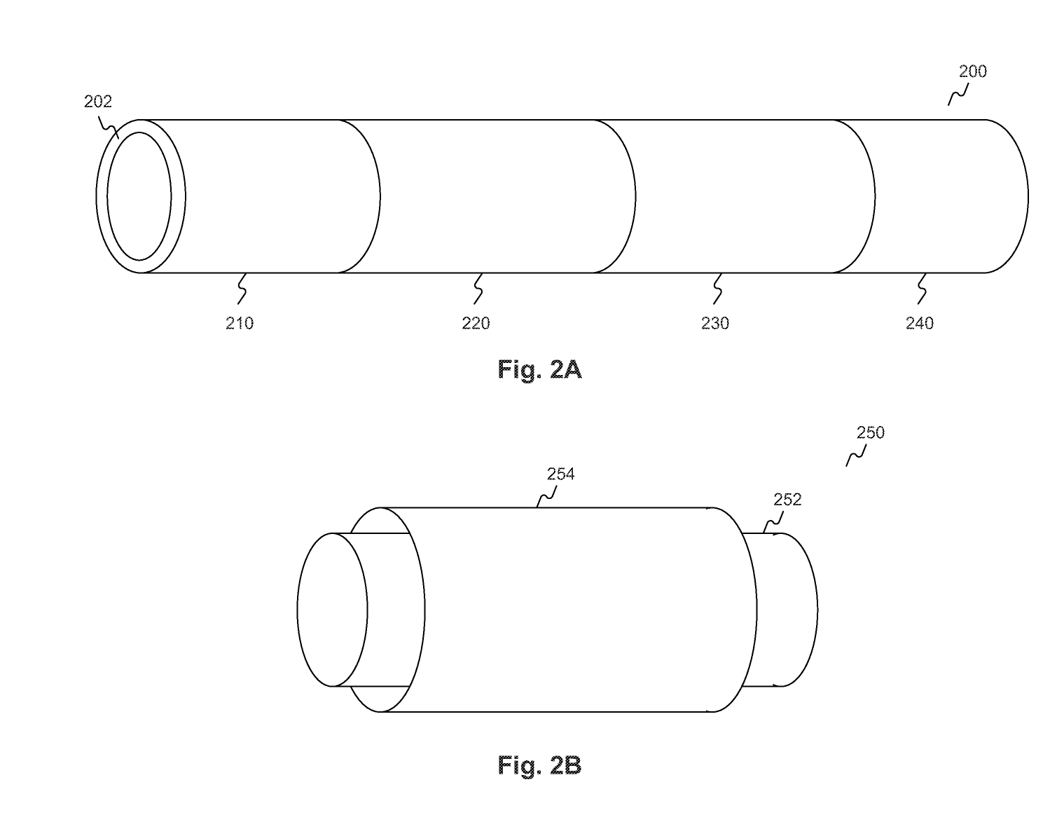

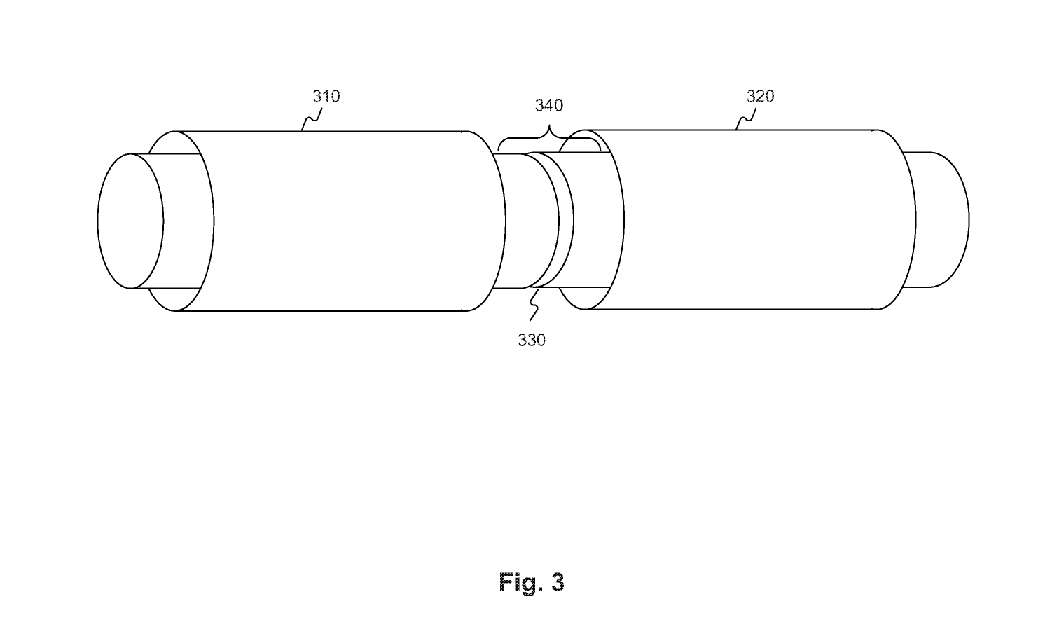

### DETAILED DESCRIPTION

The following detailed description refers to the accompanying drawings. Wherever possible, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the present disclosure is defined by the appended claims.

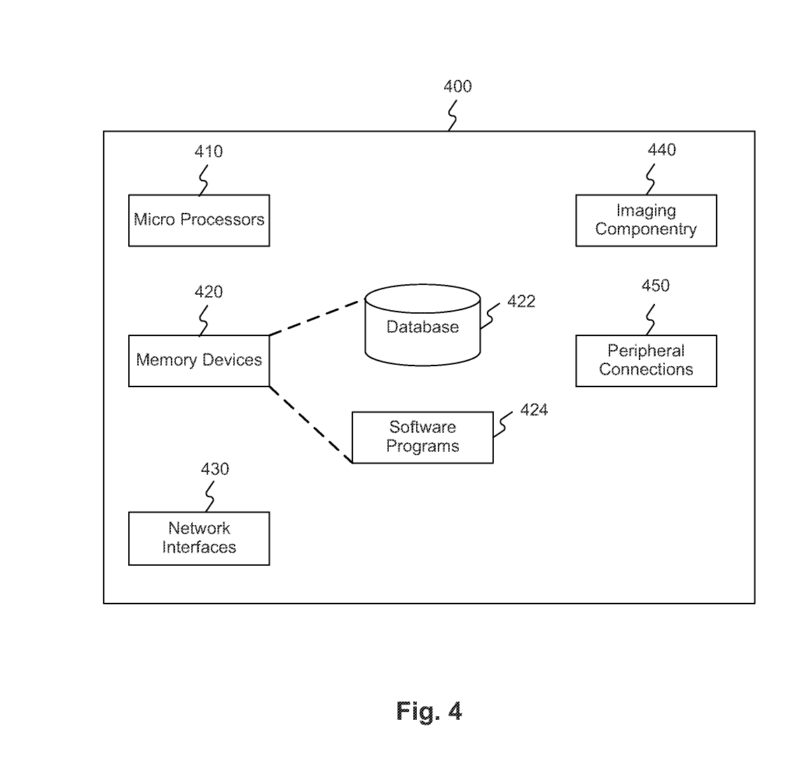

FIG. 4 is a diagram depicting exemplary hardware componentry of a computing system configured to perform the described embodiments, consistent with certain disclosed embodiments. System 400 can include one or more microprocessors 410 of varying core configurations and clock frequencies; one or more memory devices or computer-readable media 420 of varying physical dimensions and storage capacities, such as flash drives, hard drives, random access memory, etc., for storing data, such as images, files, and program instructions for execution by one or more microprocessors 410; one or more network interfaces 430, such as Ethernet adapters, wireless transceivers, or serial network components, for communicating over wired or wireless media using protocols, such as Ethernet, wireless Ethernet, code divisional multiple access (CDMA), time division multiple access (TDMA), etc.; one or more imaging componentry 440, such as devices capable of capturing x-ray images of pipeline components; and one or more peripheral connections 450, such as keyboards, mice, touchpads, computer screens, etc., for enabling human interaction with and manipulation of system 400. The components of system 400 need not be enclosed within a single enclosure or even located in close proximity to one another.

Memory devices 420 can further be physically or logically arranged or configured to provide for or store one or more data stores, such as one or more file systems or databases 422, and one or more software programs 424, which can contain interpretable or executable instructions for performing one or more of the disclosed embodiments. Those skilled in the art will appreciate that the above-described componentry is exemplary only, as system 400 can include any type of hardware componentry, including any necessary accompanying firmware or software, for performing the disclosed embodiments. System 400 can also be implemented in part or in whole by electronic circuit components or processors, such as application-specific integrated circuits (ASICs) or field-programmable gate arrays (FPGAs).

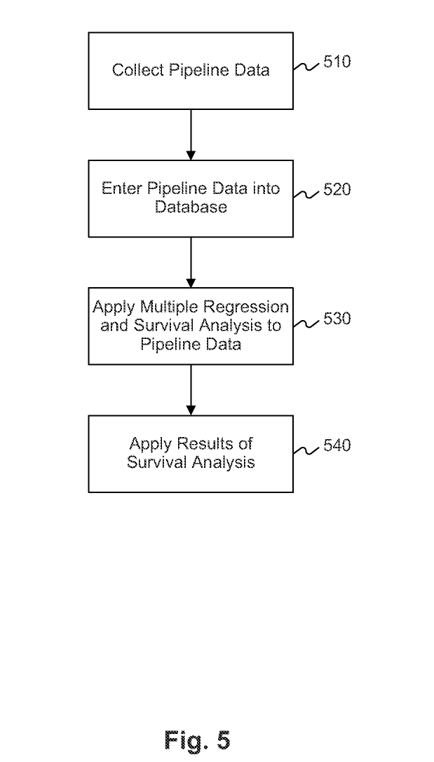

FIG. 5 is a flow diagram depicting an exemplary method of using multiple regression to determine the causal factors most relevant to the initiation of CUI and using survival analysis to predict CUI initiation in pipeline joints, consistent with certain disclosed embodiments. FIG. 5 presents a high-level overview of four main stages of the overall process. Subsequent figures will provide further details for each of the four stages.

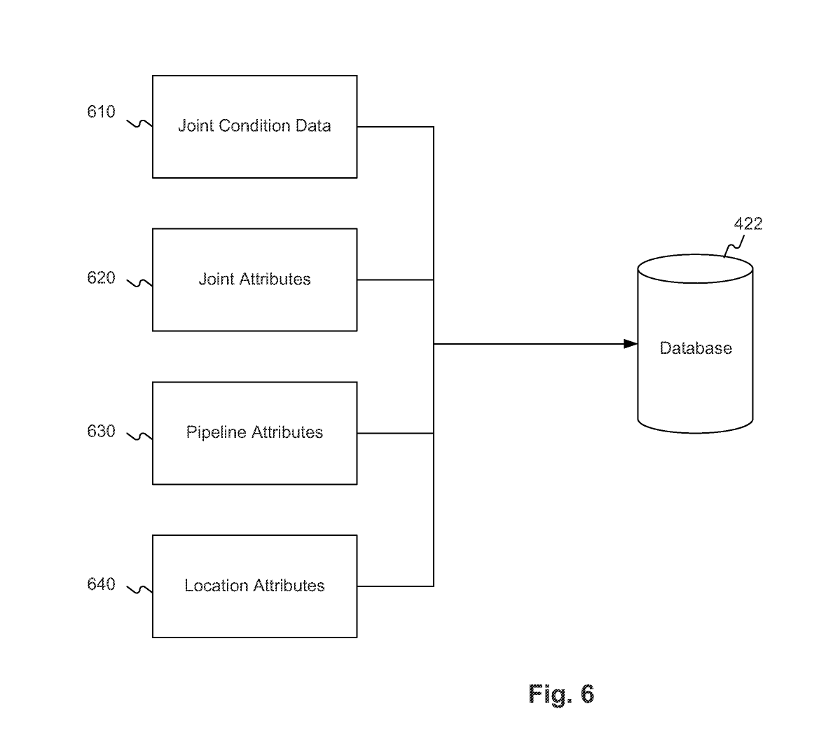

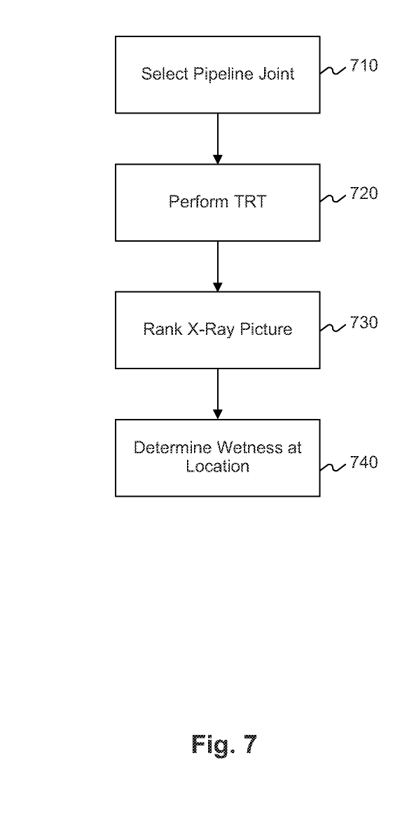

In step 510, pipeline data is collected. FIG. 6 depicts four basic categories of pipeline data: joint condition data 610, joint attributes 620, pipeline attributes 630, and location attributes 640. Joint condition data 610 can include any information reflecting an actual state of a particular pipeline joint at a particular time, for example, as determined by a manual inspection of the pipeline joint. An exemplary method of determining joint condition data 610 is depicted in FIG. 7, consistent with certain disclosed embodiments. The steps of FIG. 7 may be performed for a plurality of pipeline joints, whether in the same pipeline or different pipelines.

In step 710, a pipeline joint is selected within a pipeline. The pipeline joint may be selected, for example, during the course of an inspection campaign in which an inspection team inspects an entire pipeline from beginning to end, including its constituent pipeline segments and pipeline joints. Once the pipeline joint has been selected, in step 720, the inspection team performs a process known as tangential radiography testing (TRT), in which one or more x-ray photographs are taken of a pipeline joint, for example using imaging componentry 440. The x-ray photographs may be taken through the lagging of the pipeline joint at a six o'clock (or bottom) position with respect to the pipeline joint, since it may be assumed that the moisture would be most likely to collect at the lowest point due to gravity.

In step 730, the pipeline joint is ranked according to its current level of CUI. For example, in one embodiment, pipeline joints can be ranked according to five different levels of corrosion, A through E. In this example, stage A may represent the lack of any detectable corrosion in the pipeline joint, stage E may represent corrosion to the point that a pipeline joint is on the verge of losing the capability to contain a particular fluid at a particular design pressure, and stages B through D may represent progressive corrosion states between A and E. In a typical production field, the number of pipeline joints falling within each category is usually distributed in a decreasing fashion.

Thus, in step 730, an inspector may examine the x-ray photographs produced by the TRT scan to make a determination as to which stage the pipeline joint is in with respect to CUI. In particular, in an x-ray photograph, corrosion products such as rust may be discerned as having a different color or shadow effect relative to non-corroded parts of the pipeline joint. This visual information can allow an inspector to determine the extent of the corrosion and thus assign a ranking to the pipeline joint. In addition, in step 740, the inspector can make a manual determination—e.g., either in relation to the TRT image or by inspection of the pipeline lagging itself—of whether there is actual moisture on or near the pipeline joint and, if so, how much moisture is present. As depicted in FIG. 6, all such information (i.e., joint condition data 610) can be catalogued in one or more databases 422.

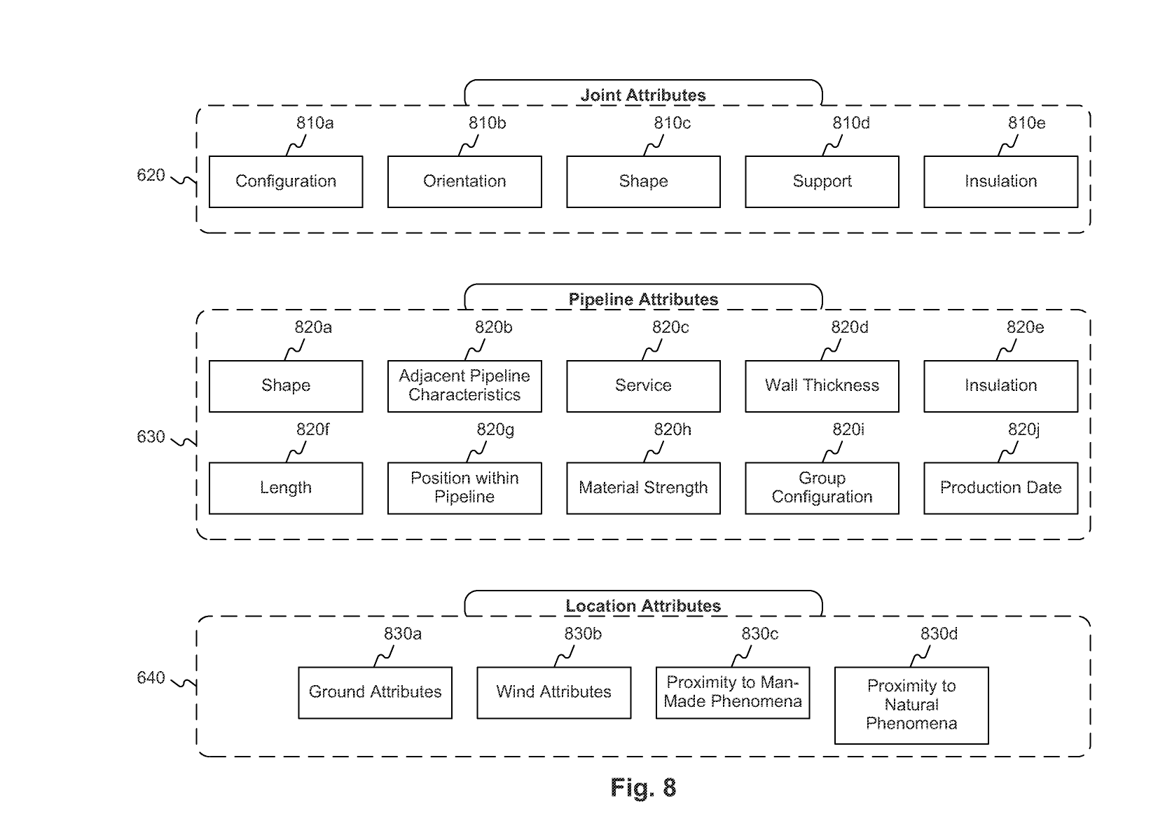

In addition to joint condition data 610, joint attributes 620, pipeline attributes 630, and location attributes 640 can also be collected. In some embodiments, whereas joint condition data 610 may describe the actual conditions of pipeline joints with respect to CUI, attributes 620-640 may include the various factors that could potentially affect those conditions. FIG. 8 is a diagram depicting exemplary categories of data that can be included in attributes 620-640.

For example, joint attributes 620 can include configuration data 810a, reflecting the particular joint configuration used. Pipeline joints may also have differing orientations, depending on the orientation of the pipeline segment in which they are used. For example, some joints may be used as part of a horizontal pipeline, whereas other joints may be used as part of a vertical pipeline or a diagonal pipeline of varying degrees. The degree of orientation may affect the rate of corrosion, since some pipeline orientations, such as vertical or diagonal, may not allow moisture to accumulate or remain to any significant degree due to gravity. Thus, joint attributes 620 can include orientation data 810b.

Joint attributes 620 can also include shape data 810c, which may reflect various physical characteristics of the pipeline joint, such as diameter and wall thickness. Joint attributes 620 can also include support data 810d reflecting whether a pipeline joint is resting on any kind of support—for example, a bridge-like structure to maintain a generally linear course despite variations in the topography of the land. Finally, joint attributes 620 can include insulation data 810e reflecting information about the pipeline joint's surrounding insulation, such as its composition, its thickness, and the manner in which it was applied to the pipeline joint. Those skilled in the art will appreciate that the foregoing joint attributes are exemplary only, and that data regarding other attributes can be similarly identified and collected.

Pipeline attributes 630 can include a variety of attributes that reflect the pipeline in which a pipeline joint resides. Such information may be beneficial toward determining additional causal factors for CUI that would not be apparent from merely inspecting the pipeline joint under consideration. For example, pipeline attributes 630 can include shape data 820a, such as information about diameter variations along the pipeline. Pipeline attributes 630 can also include information 820b about adjacent pipeline segments or joints, such as the joint attributes 620 of those segments or joints.

The nature of materials transported through pipelines may also factor into the rate of corrosion. For example, different liquids or gases may be transported through the pipelines at different pressures or temperatures, which may affect conditions on the outside of the pipeline, underneath the insulation. Thus, pipeline attributes 630 can include service information 820c indicating which materials have been transported using the pipeline over time.

Similar to joint attributes 620, pipeline attributes 630 can also include information 820d about the wall thickness of the pipeline, including how the wall thickness may vary over the length of the pipeline, and insulation information 820e including information about the composition, thickness, and application method of the insulation as it varies over the length of the pipeline. Pipeline attributes 630 can also include length information 820f indicating the length of a pipeline, either as a whole or with respect to a particular region, and position data 820g indicating the position of the pipeline joint within the pipeline or pipeline region. Information about the particular kinds of material from which the pipeline has been constructed and their material strength 820h can also be considered.

The relation of the pipeline with respect to other pipelines may also be relevant to how CUI develops in the pipeline joint under investigation. For example, in order to achieve various efficiencies, pipelines may be grouped together to run across certain geographical stretches in groups of between ten and fifteen pipelines. The location of a particular pipeline within a group configuration may therefore be important. For example, pipelines toward the outside of a group configuration may be more susceptible to damage from environmental conditions or external objects, such as debris. Thus, pipeline attributes 630 can include group configuration information 820i. Finally, pipeline attributes 630 can include information 820j concerning the pipeline's production date, which may indicate the date on which or the date range over which the pipeline was manufactured or installed in the production field. Those skilled in the art will appreciate that the foregoing pipeline attributes are exemplary only, and that data regarding other attributes can be similarly identified and collected.

As depicted in FIGS. 6 and 8, the collected pipeline data can also include location attributes 640, reflecting information about the environment in which pipelines and pipeline joints reside. For example, location attributes 640 can include ground attributes 830a. Ground attributes 830a can include various pieces of information about the ground over which a pipeline or pipeline joint is running, such as whether the pipeline is running over tundra; whether a pipeline or pipeline joint is crossing flowing water (e.g., on a bridge) or standing water; or whether a pipeline or pipeline joint runs underground, such as under a road, which may correspond to a low point where water might accumulate. Ground attributes 830a can further contain information about the composition of the ground over which certain pipelines or pipeline joints run, such as the soil type (including whether the soil is acidic or alkaline) and characteristics of nearby water, which may be freshwater or saltwater.

Location attributes 640 can also include wind attributes 830b, which may measure the direction, magnitude, and/or composition of wind that blows over a certain pipeline or pipeline joint. For example, whether wind-blown dust regularly reaches a given pipeline joint, and whether that dust is alkaline, acidic, or neutral, may affect the onset of CUI.

Location attributes 640 can also include information 830c indicating a pipeline joint's proximity to various man-made phenomena. For example, if a pipeline joint is near a power plant, that information, coupled with wind attributes 830b, it can be used to determine how much of the effluent that exits the power plant reaches and accumulates on the pipeline joint. Similarly, if the pipeline joint is downwind of a gas turbine exhaust, fumes, such as nitrous or sulfur oxides, may act to acidify any moisture that was condensing on a pipeline under the insulation, thus contributing to accelerated CUI.

Location attributes 640 can also include information 830d indicating a pipeline joint's proximity to various naturally occurring phenomena, such as lakes, rivers, mountains, etc. For example, if a particular pipeline is within a certain distance of a lake, such information can be coupled with wind attributes 830b to determine the likelihood or extent of moisture that may accumulate on the pipeline through wind-blown moisture originating from the lake. Those skilled in the art will appreciate that the foregoing location attributes are exemplary only, and that data regarding other attributes can be similarly identified and collected.

Information in joint attributes 620, pipeline attributes 630, and location attributes 640 can be collected in a variety of ways. In some cases, various factors belonging to all three categories can be collected during the course of inspecting a particular pipeline or pipeline joint. In other cases, some information may also be known in advance. For example, the support 810d of a particular pipeline joint may be known in advance based on records, such as blueprints, that detail how the pipeline was to be constructed over a particular area. Similarly, pipeline attributes such as wall thickness 820d, material strength 820h, and production date 820j may be known in advance based on blueprints or other schematics. Some location attributes may also be known in advance based on design documentation. Attributes that are expected to remain largely constant over the lifetime of a pipeline or pipeline joint may also be known in advance from having been collected during the course of one or more previous inspections.

In some embodiments, various attributes, such as location attributes 640, can be determined by making use of global information systems (GIS) data. For example, provided an x-y coordinate pair for a particular pipeline joint is known (e.g., through inspection or design information), a corresponding GIS polygon containing the coordinate pair can be determined. Data from GIS records for the polygon can then be consulted to determine known attributes of the polygon, such as ground attributes 830a. Using known GIS techniques, distances between the polygon and man-made 830c and natural 830d phenomena in the GIS database can also be computed.

Thus, data-gathering techniques, such as on-site inspection, consultation of pre-compiled data sources, and GIS inspection, joint attributes 620, pipeline attributes 630, and location attributes 640 can be determined. Those skilled in the art will appreciate that a particular attribute may be determined using more than one of these techniques. For example, an on-site inspection may enable an inspection team to manually verify insulation information 810e, even though such information might have already been entered into database 422 upon manufacture and installation of the pipeline joint. Similarly, the value of a particular attribute might initially be learned by means of on-site inspection or GIS analysis. Yet, once that attribute is entered into the database, it may be consulted in the future as pre-known data.

Because pipelines are typically long and include many individual pipeline joints, it may not be feasible to inspect all pipeline joints in a pipeline, let alone in an entire production field. Moreover, as described above, given the generally non-linear nature of the advancement of corrosion, even a robust inspection program may not be able to detect CUI in some pipeline joints before it is able to reach an extreme stage. Thus, there is a need to predict when CUI is likely to begin for pipeline joints independent of when such pipeline joints may be inspected or even whether some pipeline joints are inspected at all.

The present disclosure leverages multiple regression analysis and survival modeling to achieve these and other goals. Using pairs of condition data for inspection of individual pipelines at two different times, along with attributes of those pipeline joints, pipelines, and locations, multiple regression analysis can be performed to identify the factors that most contribute to CUI onset or acceleration. Survival analysis can also be applied to the collected data to determine one or more functions such as the survival time of a given pipeline joint with a particular set of characteristics. Particular survival functions can also be determined for predicting how CUI may progress in individual pipeline joints between specific, identifiable CUI stages. Attention will now be turned toward exemplary steps for performing these and other operations.

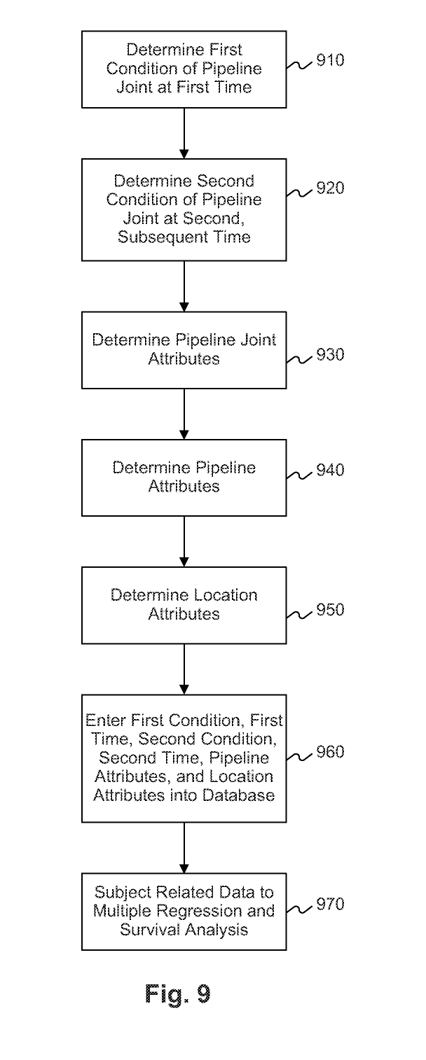

As described with respect to FIGS. 6-8, various pieces of information can be collected for a plurality of pipeline joints and entered into a database. However, in some embodiments, in order to derive meaningful conclusions as to the effects of various factors on the progression of CUI in a pipeline joint from one stage to another, it may be necessary to consider the condition of the pipeline at more than one point in time. FIG. 9, therefore, depicts exemplary operations for relating any collected joint, pipeline, and location attributes not merely to a past or present condition of a pipeline joint, but to a change in the condition of the pipeline joint over time.

In step 910, a first condition of a pipeline joint is determined at a first time. Next, in step 920, a second condition of a pipeline joint is determined at a second, subsequent time. In step 930, the pipeline joint's attributes, such as pipeline joint attributes 620, are determined. In step 940, attributes of the pipeline in which the joint resides, such as pipeline attributes 630, are determined. In step 950, attributes of the location of the pipeline joint, such as location attributes 640, are determined. In step 960, all of this information can be entered into a database, such as database 422. In step 970, the foregoing data may be related or associated and subjected to multiple regression and survival analysis.

Those skilled in the art will appreciate that the steps depicted in FIG. 9 need not occur in the precise order depicted. For example, any one of the collected joint, pipeline, and location attributes can be collected prior to collection of the first condition data or subsequent to collection of the second condition data. Some attributes can also be collected during either the first inspection or the second inspection. Attributes can also be entered into the database upon collection, rather than delaying entry until all necessary data has been collected. Moreover, although step 970 reflects the fact that multiple regression and survival analysis may be performed on all of the related data for a particular pipeline joint, in practice, such analysis may instead provide meaningful results only when data for a sufficient number of different pipeline joints is included in the calculations. Thus, step 970 need not be performed immediately after step 960, but operations can instead be delayed until similar information for a large number of different pipeline joints has also been collected and entered into the database.

Once the necessary data has been collected for a sufficient number of distinct pipeline joints, analysis can then be performed on the data to determine statistically significant relationships between related factors and related pipeline joints. In some embodiments, multiple regression analysis can be applied to pipeline joint condition pairs to determine the factors most likely to cause CUI. In other embodiments, specific attention may be given to transitions between particular CUI stages.

As described above, a pipeline joint can be classified into one of five different stages depending on its level of CUI. For example, stage A may represent the state in which no CUI can be detected on a given pipeline joint, whereas stage E may represent the state in which CUI has progressed to the point that a pipeline joint loses containment. In between, stages B, C, and D may represent levels of corrosion for which certain remedial actions can be taken or for which certain policy considerations will govern.

For example, if a pipeline joint is found to have CUI in stage B, then certain remedial actions may be taken to restore the pipeline joint back to stage A. Stage C might represent a state of corrosion in which it would not be possible or practical to bring the pipeline joint back to an earlier stage, such as A or B, but for which actions may still be taken to retard or suspend the advancement of the CUI. Similarly, stage D may represent a stage of corrosion in which it is no longer possible to restore the pipeline joint to a healthier status, but yet there still remains time to replace the pipeline joint before it loses containment. Those skilled in the art will appreciate that the foregoing stage descriptions are exemplary only, and that other logical schemes can exist for categorizing pipeline CUI.

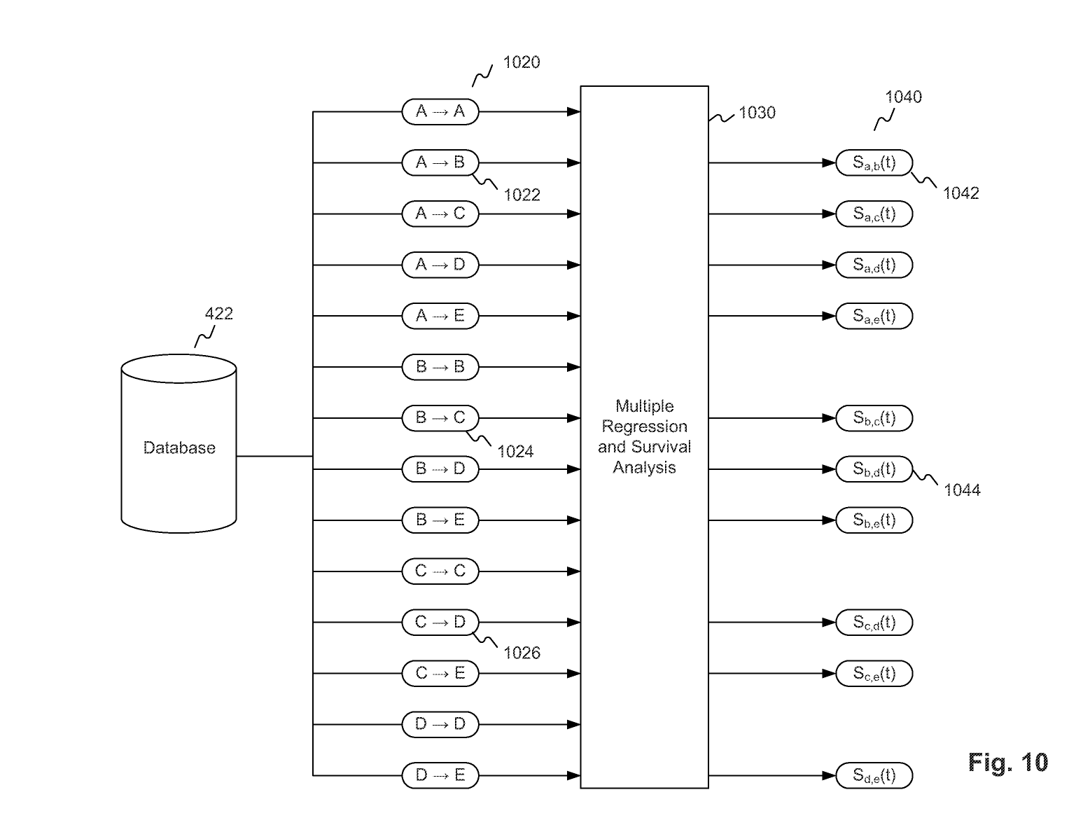

Because each different stage can have important policy considerations, one novel aspect of the present disclosure is the use of survival analysis to predict not merely the likely timeframe until the progression of corrosion in a pipeline to CUI stage E, but also to predict likely timeframes between different pairs of stages in the pipeline joint lifetime. Accordingly, FIG. 10 is a diagram depicting an exemplary process of using multiple regression analysis to predict time-to-event data with respect to multiple pairs of CUI stages.

As depicted in FIG. 10, data from database 422 can be queried and sorted to derive multiple sets of pairs 1020 of distinct CUI stage data points. For example, database 422 can be queried to identify all records 1022 in which a given pipeline joint was identified as being in stage A during a first inspection and the same pipeline joint was identified as being in stage B during a second, subsequent inspection. Similar records can be identified in which particular pipeline joints progressed from stage B to stage C between inspections (records 1024) or from stage C to D (records 1026), etc. Data reflecting each set of pairs 1020 can be provided as an input to a multiple regression and survival analysis module 1030, from which regression coefficients and survival analysis functions 1040 can be obtained.

In some embodiments, multiple regression analysis may refer to linear regression analysis in which the relationship between a dependent variable and a plurality of independent variables is determined. More specifically, multiple regression analysis may be used to understand how the typical value of a dependent variable changes when any one of the independent variables is varied while the other independent variables are held constant. Multiple regression analysis can also be used to derive one or more expressions for the value of the dependent variable as a function of the independent variables. Once a regression function is derived, the variation of the dependent variable around the regression function can be determined and expressed in terms of a probability distribution.

In the present disclosure, multiple regression may be performed using dependent variables that represent intervals, a technique that may also be referred to as lifetime regression. For example, if a first inspection of a pipeline joint reveals that the pipeline joint is in CUI stage A, and a second inspection reveals that the pipeline joint is in still in CUI stage A, the interval can be considered open. However, if the second inspection reveals that the pipeline joint is in CUI stage B, then it can be known that the change occurred during the interval between inspections.

Returning to FIG. 10, for each pair set 1020, data representing the date of the first inspection and the date of the second inspection (or simply the time difference between the two inspections); the first and second conditions detected for the given pipeline joint; and the associated joint attributes 620, pipeline attributes 630, and location attributes 640 can be provided as input data to multiple regression and survival analysis module 1030. In some embodiments, the time difference, joint attributes, pipeline attributes, and location attributes can be supplied as independent variables, and the time difference between CUI stage changes and/or the nature of the stage changes themselves can be provided values for one or more dependent variables. Then, by applying multiple regression analysis to various subsets of inputs 1020, module 1030 may output one or more sets of regression coefficients, expressed within survival analysis functions 1040, reflecting the relative importance or effect of particular independent variables on the dependent variables.

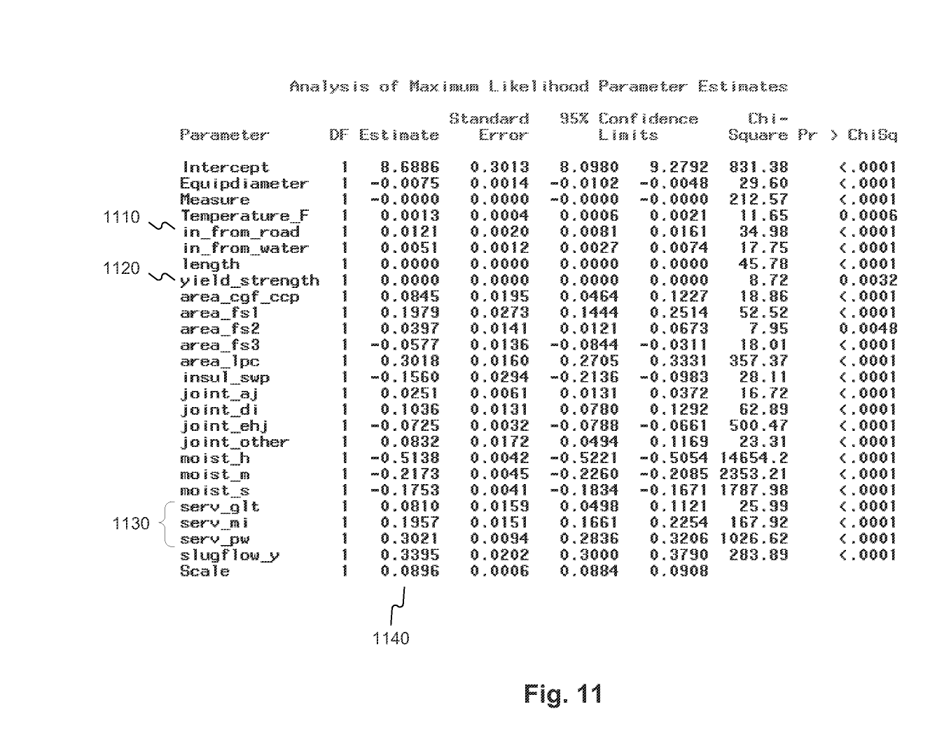

FIG. 11 depicts an exemplary output of multiple regression analysis module 1030, in which various attributes such as a pipeline joint's distance from the nearest road 1110, yield strength 1120, and service attributes 1130 are represented as independent variables, each having a determined regression coefficient 1140. Those skilled in the art will appreciate that the multiple regression analysis output of FIG. 11 is exemplary only.

In some embodiments, multiple regression and survival analysis module 1030 can also apply various survival analysis techniques to derive one or more sets of survival functions 1040. With respect to detecting CUI in pipeline joints, a given pipeline joint's date of manufacture or field installation may correspond to that pipeline joint's date of birth for purposes of survival analysis. Similarly, once a pipeline joint reaches a level of corrosion, such as stage E, in which it loses containment ability, that event may represent a type of end of the pipeline joint's lifetime for purposes of survival analysis. In some embodiments, this concept can be expanded to account for the multiple stages of CUI discussed above, in which a progression from one CUI stage to a subsequent CUI stage may be considered an event. The application of survival analysis to such events may also be referred to as recurrent event survival analysis. Similarly, in some embodiments, if the time to an event is measured from a previous inspection time (e.g., a first-inspection/second-inspection pair comprising CUI stages B and C, respectively), then the first inspection time may be regarded as birth date for purposes of survival analysis, even if an actual manufacturing or field installation date for the pipeline joint is known.

In some embodiments, multiple regression and survival analysis module 1030 can perform survival analysis using both right censoring and left censoring. In survival analysis, right-censoring is a technique used to account for a subject for which it is known only that an occurred (or will occur) subsequent to a given point in time, such as when the actual date of the event is not known or has not yet occurred. Thus for any given pipeline joint for which two different inspections have yielded discovery of two different stages of CUI, a set of right-censored data pairs can be generated based on all stages that occur subsequent to the stage detected in the second inspection.

For example, for data pairs 1022, in which pipeline joints have been found to be in CUI stage A on first inspection and CUI stage B on second inspection, additional data records A→C, A→D, and A→E can be generated for each pipeline joint in the data set reflecting that, as of the date of the second inspection, the pipeline joint was found not to have reached CUI stages C, D, or E, respectively. In each of these additional data records, the time-to-event variable may be the same as that of the pair for which A→B time has been recorded; however, each of the additional data records can be marked as right-censored so that the time-to-event is taken only as an indication that an A→C, A→D, or A→E transition had not yet occurred as of the date of the second inspection when survival analysis is performed. Thus for any given pipeline joint for which two different inspections have yielded discovery of two different stages of CUI, a set of right-censored data pairs can be generated based on all CUI stages that will eventually occur subsequent to the stage detected in the second inspection.

Conversely, in survival analysis, left-censoring is a technique used to account for data in which it is known only that an event occurred prior to a given point in time, yet the actual date of the event is not known. For example, if inspection of a pipeline joint reveals that the pipeline joint is in CUI stage B, but the timeframe for the pipeline joint's transition from stage A to stage B is not known, that data may be entered into a survival analysis calculation as left-censored data. Here, all of the data pairs 1022 may be left-censored. Thus, the inputs to multiple regression and survival analysis module 1030 can be both left-censored and right-censored.

Survival analysis can be performed on the left-censored data pairs 1022, as well as on any right-censored data pairs based on data pairs 1022, as described above. The output of the survival analysis may comprise a variety of functions or probability distributions. For example, a plurality of survival functions 1040 can be generated. A survival function may be defined as an expression in the form of S(t)=PR(T>t), representing the probability that the time of an event T for a given subject is later than some specified time t. For example, survival function 1042, denoted S_{a,b}(t), may represent the likelihood that a given pipeline joint presently known to be at CUI stage A will be at CUI stage B given a supplied elapsed time t. By evaluating the output of function S_{a,b}(t) for all values of t over a range of values, a probability distribution can be generated that indicates the most likely point in time when the pipeline joint will transition from CUI stage A to CUI stage B. The same may be said for exemplary survival function 1044, which can be used to determine the likely point in time when a given pipeline joint presently in CUI stage B will transition to CUI stage D. However, in this example, the confidence with which survival function 1044 can predict the time before a pipeline joint in CUI stage B would progress to CUI stage C may be higher than the confidence of a predicted time to progress from stage B to D.

Survival functions 1040 may also allow various parameters, such as joint attributes 620, pipeline attributes 630, and location attributes 640, to be provided as inputs to the survival calculations, such that the predicted survival probabilities take into account the values of specific attributes for any given pipeline joint. These attributes can be configured into the output survival probability of the pipeline joint by using the results from the above-described multiple regression analysis, such as the regression coefficients depicted in FIG. 11. In some embodiments, multiple regression and survival analysis module 1030 may make use of one or more functions provided by a statistical analysis software (SAS) package, such as the LIFEREG procedure provided by SAS® 9.2, as described in Survival Analysis Using SAS®: A Practical Guide, (2nd ed.), by Paul D. Allison.

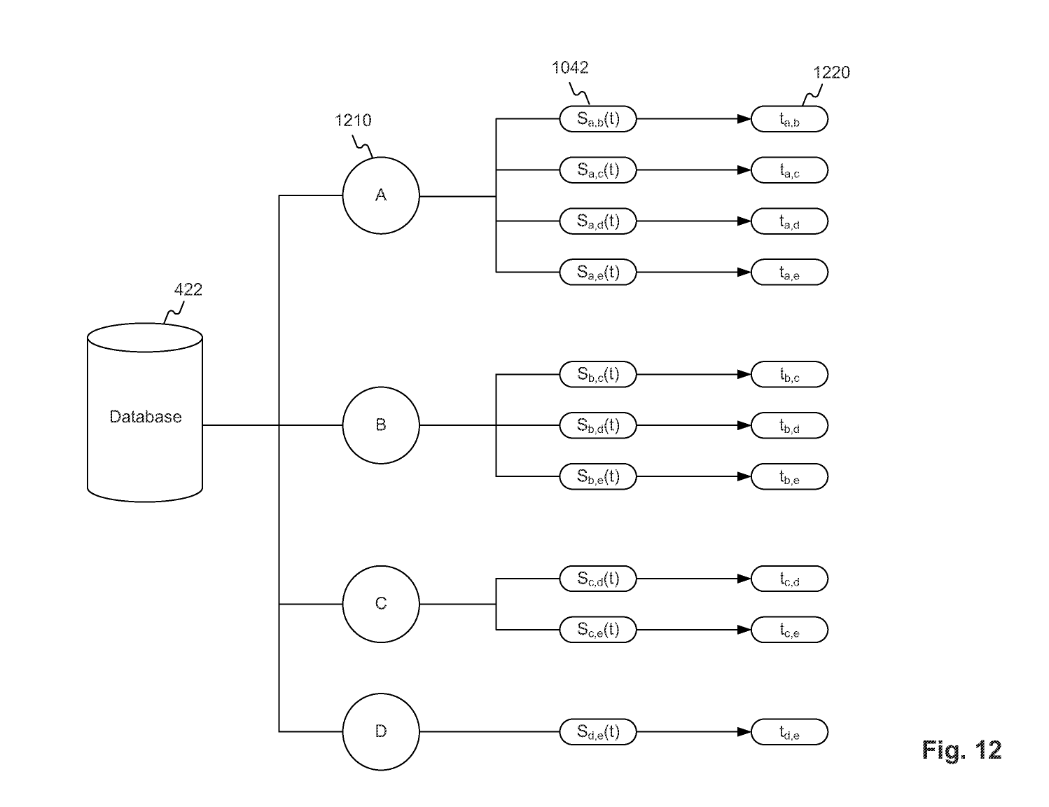

Returning to FIG. 5, after multiple regression and survival analysis has been performed on the pipeline data input into the database, thus resulting in predictive functions, such as survival functions 1040, in step 540, the results of that analysis can be used to make predictions about current CUI levels in the same or other pipeline joints in the database. For example, as depicted in FIG. 12, database 422 can be queried and/or sorted to identify all records 1210 reflecting pipeline joints identified as being in stage A upon the most recent inspection. For each such pipeline joint, associated joint attributes, pipeline attributes, and location attributes can be input into one or more survival functions, along with a relevant “birth” date, such as the date of the pipeline joint's manufacture, field installation, or last inspection, to derive an expected lifetime of the pipeline joint before it transitions to a subsequent stage.

For example, data reflecting a given pipeline joint last determined to be in CUI stage A can be input into survival function 1042. Survival function 1042 may then output a time 1220, denoted t_{a,b}, that indicates how much time is predicted to elapse (e.g., from manufacture data, installation date, or last inspection date) before the pipeline joint transitions from CUI stage A to CUI stage B. For the same pipeline joint, expected lifetimes t_{a,c}, t_{a,d}, and t_{a,e} can also be determined for predicting expected lifetimes until the pipeline joint transitions to CUI stages C, D, and E, respectively. Any pipeline joint belonging to dataset 1210 can also be subjected to the foregoing survival functions to identify expected lifetimes before transitions to CUI stages C, D, or E. Similarly, as depicted in FIG. 12, pipeline joints identified as being in CUI stage B can be provided as inputs to survival functions capable of predicted expected lifetimes before transitioning to stages C, D, or E. And, the same may be done for pipeline joints in stages C or D, for predicting transitions to subsequent CUI stages.

Those skilled in the art will appreciate that the foregoing application of the outputs of survival analysis is exemplary only and that many other variations may exist. For example, survival functions 1040 can be used to predict expected lifetimes not only of pipeline joints that have been previously inspected, but also of pipeline joints that have never been inspected. In this embodiment, the pipeline joint's last inspection date may be regarded as identical to its manufacture or field installation date, and its last condition may be assumed to be CUI stage A. Those skilled in the art will appreciate that other variations exist.

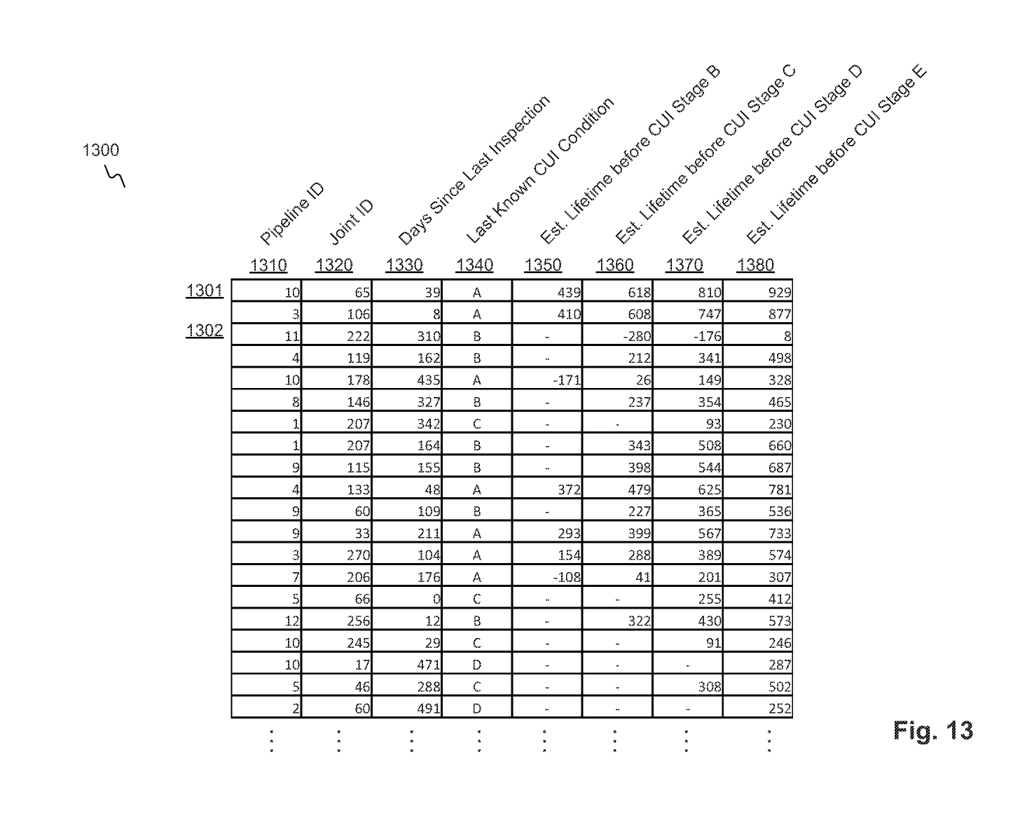

Using these techniques, or variations of the above techniques, for each pipeline joint in a production field, predicted lifetimes can be calculated for each subsequent CUI stage to which the pipeline joint might progress. FIG. 13 depicts an exemplary chart or table 1300 that reflects such exemplary calculations for a plurality of pipeline joints.

As depicted in FIG. 13, each pipeline joint may be represented by the unique combination of its “Joint ID” (column 1320) and the “Pipeline ID” of its associated pipeline (column 1310). Column 1330 may indicate the number of days since the particular pipeline joint was last inspected, and column 1340 may indicate the condition of the pipeline joint as determined during the last inspection. For pipeline joints that have never been inspected, column 1330 may contain the number of days since the pipeline was manufactured or installed in the field, and the condition may be assumed to be CUI stage A.

For each pipeline joint, columns 1350 through 1380 may present predicted lifetimes (e.g., measured from a current date or the date of the last inspection) before the pipeline joint progresses to each subsequent CUI stage. For example, in row 1301, pipeline joint 65 (resident in pipeline 10) was last inspected 39 days ago, and was found to be in condition A. In column 1350, survival analysis (e.g., application of the survival function S_{a,b}(t)) has predicted that the pipeline joint is likely to transition to CUI stage B after approximately 439 days, based on the data associated with the pipeline joint (e.g., its joint attributes, associated pipeline attributes, and location attributes, as well as any moisture detected upon inspection). Columns 1360 through 1380 indicate that survival analysis (e.g., application of the survival functions S_{a,b}(t), S_{a,c}(t), and S_{a,d}(t)) has predicted that the pipeline joint is likely to progress to CUI stages C, D, and E after 618 days, 810 days, and 929 days, respectively.

Looking now at row 1302, it can be seen that pipeline joint 222 (resident in pipeline 11) was found in condition B during its last inspection. Because survival analysis assumes a non-improving progression for the survival function as time t increases, and because the pipeline joint has already progressed to stage B, there may be no data for column 1350 for this particular pipeline joint. There may, however, be estimated lifetimes for progressions to CUI stages C, D, and E, in columns 1360, 1370, and 1380, respectively.

In this example, because columns 1360 and 1370 have negative values, it has been predicted that this pipeline joint has already progressed to stage C, and then to stage D, since the last inspection 310 days ago. In particular, it is predicted that the pipeline joint reached stage C approximately 280 days ago (or 30 days after the last inspection). Similarly, column 1370 contains a negative value (−176), reflecting the prediction that this pipeline joint has also progressed to CUI stage D since the last inspection. And because column 1380 contains a positive value (here, 8), it is predicted that the pipeline joint has not yet reached CUI stage E, but is presently in CUI stage D (for at least the next, approximately, 8 days).

Thus, in table 1300, positive values in any of columns 1350 through 1380 may represent estimated lifetimes until a particular pipeline joint progresses from one CUI stage to another CUI stage, whereas negative values may represent predictions that particular pipeline joints have already progressed to later CUI stages since their last inspections. Those skilled in the art will appreciate that table 1300 is exemplary only, and that other techniques can be used for organizing the results of survival analysis for a plurality of distinct pipeline joints.

Once the results of survival analysis for a plurality of pipeline joints have been determined, such as those depicted in FIG. 13, the results can be used to shape policy decisions in a number of ways. As one elementary application, by determining a likely timeframe for a corrosion event in a given pipeline joint, a pipeline owner can direct a maintenance team to the pipeline joint for preventative maintenance before the predicted event occurs or to repair the pipeline joint after the predicted event to prevent further corrosion. This elementary application by itself presents a significant advancement over existing techniques, since it may otherwise be impractical or impossible to detect such CUI transition events in different pipeline joints across large numbers of pipelines and pipeline joints with manual inspection methods. By expanding this predictive knowledge to a plurality of pipeline joints, pipeline owners can plan various repair campaigns that will take preventative measures or remedial actions for the greatest number of pipeline joints in need of such attention given limited resources for campaigns and a limited number of campaigns.

As another application, by determining the regression coefficients and observing patterns across the pipeline joints for which CUI progresses the most rapidly, a pipeline owner can determine what factors (e.g., joint factors, pipeline factors, location factors, and/or moisture conditions) are most relevant to CUI initiation or advancement. Using this determined information, a pipeline owner can make future design and implementation decisions to minimize such factors and thus minimize the likely speed of corrosion in future pipeline joints, pipelines, or pipeline placements. For example, if a particular elbow joint is found to initiate CUI more quickly, use of that type of joint can be minimized in the future or maintenance teams can be instructed to perform preventative maintenance on all elbow joints that they encounter during the course of repair and non-repair campaigns alike. Or, inspection teams may inspect joints where damage is expected sooner, rather than later, for confirmation of the calculated predictions in order to improve the database and the attendant data model. Those skilled in the art will appreciate that the foregoing applications of the outputs of multiple regression and survival analysis are exemplary only, and that many other different applications can be made of such information.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the present disclosure. For example, although described primarily in the context of pipeline joints, the disclosed embodiments may be equally applicable to predicting corrosion on or within other pipeline components. The disclosed embodiments can also be applied in other contexts, such as the monitoring and evaluation of water and sewer systems, natural gas distribution systems, factory piping systems, and others.

Likewise, the steps described need not be performed in the same sequence discussed or with the same degree of separation. Various steps can be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

What is claimed is:

1. A computer-implemented method of modeling predicted CUI transition lifetimes in pipeline joints, comprising:
for each pipeline joint in a plurality pipeline joints in one or more pipelines:
determining a first condition of the pipeline joint with respect to CUI at a first time;
determining a second condition of the pipeline joint with respect to CUI at a second time subsequent to the first time; and
determining a plurality of attributes associated with the pipeline joint; and
performing survival analysis modeling using the first condition, the second condition, and the plurality of attributes for the plurality of pipeline joints to derive one or more survival models reflecting one or more predicted lifetimes before a hypothetical input pipeline joint transitions from a first CUI condition to a second CUI condition.

2. The method of claim 1, wherein the plurality of attributes associated with the pipeline joint comprises:
joint attributes reflecting characteristics of the pipeline joint;
pipeline attributes reflecting characteristics of a pipeline or pipeline section in which the pipeline joint resides; and
location attributes reflecting characteristics of a geographical location in which the pipeline joint resides.

3. The method of claim 3, wherein one or more of the location attributes are derived from GIS data.

4. The method of claim 1, wherein the one or more predicted lifetimes of the hypothetical input pipeline joint predicted by the one or more survival models are based on:
joint attributes reflecting characteristics of the input pipeline joint;
pipeline attributes reflecting characteristics of a pipeline or pipeline section in which the input pipeline joint resides; and
location attributes reflecting characteristics of a geographical location in which the input pipeline joint resides.

5. The method of claim 1, wherein performing survival analysis modeling further comprises:
analyzing the second condition of one or more pipeline joints as right-censored data.

6. The method of claim 1, wherein performing survival analysis modeling further comprises:
analyzing the first condition of one or more pipeline joints as left-censored data.

7. The method of claim 1, further comprising:
performing multiple regression analysis with interval-valued response data using the first condition, the second condition, and the plurality of attributes for the plurality of pipeline joints to derive a regression coefficient associated with each attribute, wherein the regression coefficient reflects a degree to which initiation or advancement of CUI is estimated to be caused by a value of the attribute.

8. The method of claim 1, further comprising:
generating data reflecting one or more conditions and one or more attributes of an actual input pipeline joint as inputs to the one or more survival models to generate one or more predicted lifetimes before the actual input pipeline joint transitions from a first CUI condition to a different second CUI condition.

9. The method of claim 1, wherein the one or more survival models comprise a plurality of survival models reflecting predicted lifetimes before a hypothetical input pipeline joint transitions from one or more first CUI conditions to a plurality of different second CUI conditions.

10. The method of claim 9, further comprising:
generating data reflecting one or more conditions and one or more attributes associated with a plurality of actual input pipeline joints as inputs to the plurality of survival models to generate one or more predicted lifetimes before each actual input pipeline joint transitions from a first CUI condition to one or more different second CUI conditions.

11. A system configured to model predicted CUI transition lifetimes in pipeline joints, the system comprising:
a processing system comprising one or more processors; and
a memory system comprising one or more computer-readable media, wherein the computer-readable media have instructions stored thereon that, when executed by the processing system, cause the processing system to perform operations comprising:
for each pipeline joint in a plurality pipeline joints in one or more pipelines:
determining a first condition of the pipeline joint with respect to CUI at a first time;
determining a second condition of the pipeline joint with respect to CUI at a second time subsequent to the first time; and
determining a plurality of attributes associated with the pipeline joint; and
performing survival analysis modeling using the first condition, the second condition, and the plurality of attributes for the plurality of pipeline joints to derive one or more survival models reflecting one or more predicted lifetimes before a hypothetical input pipeline joint transitions from a first CUI condition to a second CUI condition.

12. The system of claim 11, wherein the plurality of attributes associated with the pipeline joint comprises:
joint attributes reflecting characteristics of the pipeline joint;
pipeline attributes reflecting characteristics of a pipeline or pipeline section in which the pipeline joint resides; and
location attributes reflecting characteristics of a geographical location in which the pipeline joint resides.

13. The system of claim 13, wherein one or more of the location attributes are derived from GIS data.

14. The system of claim 11, wherein the one or more predicted lifetimes of the hypothetical input pipeline joint predicted by the one or more survival models are based on:
joint attributes reflecting characteristics of the input pipeline joint;
pipeline attributes reflecting characteristics of a pipeline or pipeline section in which the input pipeline joint resides; and
location attributes reflecting characteristics of a geographical location in which the input pipeline joint resides.

15. The system of claim 11, wherein performing survival analysis modeling further comprises:
analyzing the second condition of one or more pipeline joints as right-censored data.

16. The system of claim 11, wherein performing survival analysis modeling further comprises:
analyzing the first condition of one or more pipeline joints as left-censored data.

17. The system of claim 11, the operations further comprising:
performing multiple regression analysis with interval-valued response data using the first condition, the second condition, and the plurality of attributes for the plurality of pipeline joints to derive a regression coefficient associated with each attribute, wherein the regression coefficient reflects a degree to which initiation or advancement of CUI is estimated to be caused by a value of the attribute.

18. The system of claim 11, the operations further comprising:
generating data reflecting one or more conditions and one or more attributes of an actual input pipeline joint as inputs to the one or more survival models to generate one or more predicted lifetimes before the actual input pipeline joint transitions from a first CUI condition to a different second CUI condition.

19. The system of claim 11, wherein the one or more survival models comprise a plurality of survival models reflecting predicted lifetimes before a hypothetical input pipeline joint transitions from one or more first CUI conditions to a plurality of different second CUI conditions.

20. The system of claim 19, the operations further comprising:
generating data reflecting one or more conditions and one or more attributes associated with a plurality of actual input pipeline joints as inputs to the plurality of survival models to generate one or more predicted lifetimes before each actual input pipeline joint transitions from a first CUI condition to one or more different second CUI conditions.

21. A method of modeling predicted CUI transition intervals in pipeline joints, comprising:
for each pipeline joint in a plurality pipeline joints in one or more pipelines:
inspecting the pipeline joint at a first time to determine a first condition of the pipeline joint with respect to CUI;
inspecting the pipeline joint at a second time subsequent to the first time to determine a second condition of the pipeline joint with respect to CUI; and
determining a plurality of attributes associated with the pipeline joint, the plurality of attributes comprising:
one or more joint attributes selected from among the set of joint configuration attributes, joint orientation attributes, joint shape attributes, joint support attributes, and joint insulation attributes;
one or more pipeline attributes selected from among the set of pipeline shape attributes, adjacent pipeline attributes, pipeline service attributes, pipeline wall thickness attributes, pipeline insulation attributes, pipeline length attributes, joint position attributes, pipeline material strength attributes, pipeline group configuration attributes, and pipeline production date attributes; and
one or more location attributes selected from among the set of ground attributes, wind attributes, proximity to man-made phenomena attributes, and proximity to natural phenomena attributes; and
generating a computer-implemented mathematical model based on inputs comprising the plurality of attributes, wherein the computer-implemented mathematical model comprises one or more survival functions capable of predicting one or more expected time intervals before a hypothetical input pipeline joint transitions from a first CUI condition to a second CUI condition based on attributes associated with the hypothetical input pipeline joint.

22. The method of claim 21, wherein one or more of the location attributes are derived from GIS data.

23. The method of claim 21, wherein generating the computer-implemented mathematical model further comprises:
analyzing the second condition of one or more pipeline joints as right-censored data.

24. The method of claim 21, wherein generating the computer-implemented mathematical model further comprises:
analyzing the first condition of one or more pipeline joints as left-censored data.

25. The method of claim 21, wherein generating the computer-implemented mathematical model further comprises:
performing multiple regression analysis with interval-valued response data using the first condition, the second condition, and the plurality of attributes for the plurality of pipeline joints to derive a regression coefficient associated with each attribute, wherein the regression coefficient reflects a degree to which initiation or advancement of CUI is estimated to be caused by a value of the attribute.

26. The method of claim 21, further comprising:
generating data reflecting one or more conditions and one or more attributes of an actual input pipeline joint as inputs to the computer-implemented mathematical model to generate one or more expected time intervals before the actual input pipeline joint transitions from a first CUI condition to a different second CUI condition.

27. The method of claim 21, wherein the computer-implemented mathematical model comprises a plurality of survival functions capable of predicting one or more expected time intervals before a hypothetical input pipeline joint transitions from one or more first CUI conditions to a plurality of different second CUI conditions.

28. The method of claim 27, further comprising:
generating data reflecting one or more conditions and one or more attributes associated with a plurality of actual input pipeline joints as inputs to the computer-implemented mathematical model to generate one or more expected time intervals before each actual input pipeline joint transitions from a first CUI condition to one or more different second CUI conditions.

29. A system configured to model predicted CUI transition intervals in pipeline joints, the system comprising:
a processing system comprising one or more processors; and
a memory system comprising one or more computer-readable media, wherein the computer-readable media have instructions stored thereon that, when executed by the processing system, cause the processing system to perform operations comprising:
for each pipeline joint in a plurality pipeline joints in one or more pipelines:
determining a first condition of the pipeline joint with respect to CUI at a first time;
determining a second condition of the pipeline joint with respect to CUI at a second time subsequent to the first time; and
determining a plurality of attributes associated with the pipeline joint, the plurality of attributes comprising:
one or more joint attributes selected from among the set of joint configuration attributes, joint orientation attributes, joint shape attributes, joint support attributes, and joint insulation attributes;
one or more pipeline attributes selected from among the set of pipeline shape attributes, adjacent pipeline attributes, pipeline service attributes, pipeline wall thickness attributes, pipeline insulation attributes, pipeline length attributes, joint position attributes, pipeline material strength attributes, pipeline group configuration attributes, and pipeline production date attributes; and
one or more location attributes selected from among the set of ground attributes, wind attributes, proximity to man-made phenomena attributes, and proximity to natural phenomena attributes; and
generating a computer-implemented mathematical model based on inputs comprising the plurality of attributes, wherein the computer-implemented mathematical model comprises one or more survival functions capable of predicting one or more expected time intervals before a hypothetical input pipeline joint transitions from a first CUI condition to a second CUI condition based on attributes associated with the hypothetical input pipeline joint.

30. The system of claim 29, wherein one or more of the location attributes are derived from GIS data.

31. The system of claim 29, wherein generating the computer-implemented mathematical model further comprises:
analyzing the second condition of one or more pipeline joints as right-censored data.

32. The system of claim 29, wherein generating the computer-implemented mathematical model further comprises:
analyzing the first condition of one or more pipeline joints as left-censored data.

33. The system of claim 29, wherein generating the computer-implemented mathematical model further comprises:
performing multiple regression analysis with interval-valued response data using the first condition, the second condition, and the plurality of attributes for the plurality of pipeline joints to derive a regression coefficient associated with each attribute, wherein the regression coefficient reflects a degree to which initiation or advancement of CUI is estimated to be caused by a value of the attribute.

34. The system of claim 29, the operations further comprising:
generating data reflecting one or more conditions and one or more attributes of an actual input pipeline joint as inputs to the computer-implemented mathematical model to generate one or more expected time intervals before the actual input pipeline joint transitions from a first CUI condition to a different second CUI condition.

35. The system of claim 29, wherein the computer-implemented mathematical model comprises a plurality of survival functions capable of predicting one or more expected time intervals before a hypothetical input pipeline joint transitions from one or more first CUI conditions to a plurality of different second CUI conditions.

36. The system of claim 35, the operations further comprising:
generating data reflecting one or more conditions and one or more attributes associated with a plurality of actual input pipeline joints as inputs to the computer-implemented mathematical model to generate one or more expected time intervals before each actual input pipeline joint transitions from a first CUI condition to one or more different second CUI conditions.
